(19) United States
(12) Patent Application Publication
(10) Pub. No.: US 2022/0116217 A1
(43) Pub. Date: Apr. 14, 2022

(54) SECURE LINKING OF DEVICE TO CLOUD STORAGE

(71) Applicant: Hewlett-Packard Development Company, L.P., Spring, TX (US)

(72) Inventors: Roger Scott Twede, Boise, ID (US); Deny Joao Correa Azzolin, Vancouver, WA (US)

(73) Assignee: Hewlett-Packard Development Company, L.P., Spring, TX (US)

(21) Appl. No.: 17/267,511

(22) PCT Filed: Nov. 14, 2018
(86) PCT No.: PCT/US2018/061026

§ 371 Date: Feb. 10, 2021

(51) Int. Cl. H04L 9/32

(52) U.S. Cl. CPC H04L 9/3213

(57) ABSTRACT

There is provided a method and system for providing authentication between a device and a cloud storage account for a user, comprising a device configured to authorise credentials for the user, authorise the device by providing a unique identifier and an encryption key, generate a ticket using the device unique identifier and user credentials, sign the ticket with the encryption key, send the signed ticket to a cloud authorisation service, and a cloud authorisation service configured to validate the signed ticket using the encryption key and match the ticket to the cloud storage account for the user via the user credentials.

### BACKGROUND

A multi-function product (MFP) such as a printing device can be securely linked to a user's cloud account. Secure and controlled access to MFP devices can be provided using an authentication solution using a user login. For example, the login may relate to a user's cloud credentials before the user gains access to cloud assets and resources.

### BRIEF DESCRIPTION OF THE DRAWINGS

Various features and advantages of certain examples will be apparent from the detailed description which follows, taken in conjunction with the accompanying drawings, which together illustrate, by way of example only, a number of features, and wherein:

FIG. 1 is a flow diagram showing a method for providing authentication between a device and a cloud storage account for a user according to an example;

FIG. 2 is a flow diagram showing an access token assigned to a user according to an example;

FIG. 3 is a schematic showing a ticket according to an example;

FIG. 4 is a flow diagram for establishing a secure communication channel between a device and cloud storage;

FIG. 5 is a flow diagram showing a method for the user to store and/or retrieve data at their cloud storage account according to an example;

FIG. 6 is a schematic showing use of an access token according to an example;

FIG. 7 is a schematic showing authentication between a device and a cloud storage account for a user according to an example;

FIG. 8 is a schematic showing a system for providing authentication between a device and a cloud storage account for a user according to an example; and

FIG. 9 is a schematic showing a processor for executing instructions to carry out a method for securely linking a device to a user's cloud account according to an example.

### DETAILED DESCRIPTION

In the following description, for purposes of explanation, numerous specific details of certain examples are set forth. Reference in the specification to “an example” or similar language means that a particular feature, structure, or characteristic described in connection with the example is included in at least that one example, but not necessarily in other examples.

Embedded authentication mechanisms can be supported in a multi-function product (MFP). Authentication mechanisms can include: Active Directory; LDAP; PIN; third party authorisation; RFID; smart card; or proximity badge readers. Cloud account authentication can be accomplished via a username and password combination, which can be a separate authorization domain from built-in or third-party authentication solutions which are embedded authentication methods in an MFP.

A method and system are disclosed for securely linking a device, such as a printing device, to a user's cloud account. For example, a secure link or bridge from an embedded MFP or printer authentication mechanism to a cloud account authorization is provided. This securely bridges the gap from any built-in or third-party MFP authentication method to a cloud authorization domain without requiring a user to re-authenticate or re-enter secondary credentials. For example, the user can use a badge swipe to both log into the MFP and log into the cloud and/or other linked cloud resources such as Google, OneDrive, or Box for example. This allows the user to have access to their personal cloud accounts & documents in addition to the MFP device features to which they have been authorized to use. A user's personalized experience can thereby easily follow a user to any capable device they use without extra effort on their part. This is achieved by establishing a secure communication channel via an authentication process. The device is assigned a unique ID and secret key which are used by the cloud service to validate a ticket request for access to the user's cloud account.

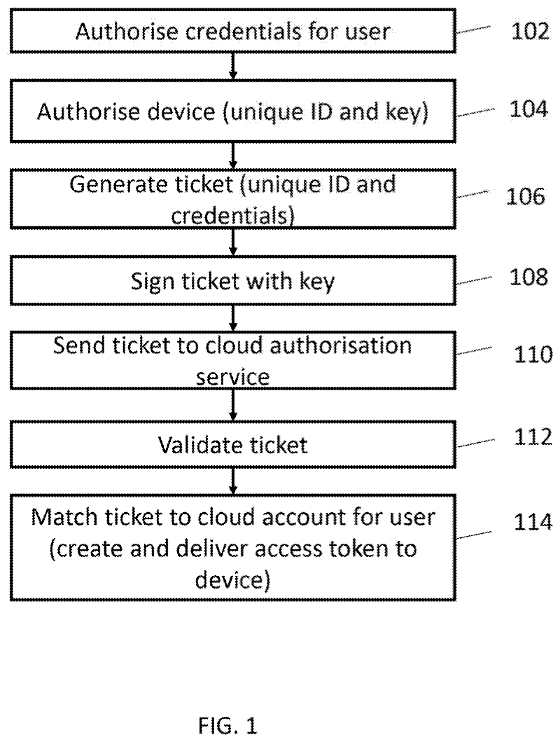

FIG. 1 shows a method for providing authentication between a device and a cloud storage account for a user according to an example. According to an example the device is a multi-function product (MFP) such as a printer.

At block 102 the method comprises, at the device, authorising credentials for the user. The user credentials may correspond to details used to qualify the user or a user identification, such as personal details. A user can log into the device with their credentials or with a physical token (e.g. RFID badge touch) in order to gain access to access-controlled device functions. Upon logging in, this can add device software such that login will initiate a secure communication sequence with the cloud to gain authorization to cloud services.

At block 104 the method comprises authorising the device by providing a unique identifier and an encryption key. According to an example, an administrator can pre-configure a built-in device (MFP) authentication agent, for example LDAP, Windows, ActiveDirectory. The administrator can pre-install a solution to perform the authentication and authorization, for example Safecom, HP Access Control, PaperCut. The administrator or authenticating agent pre-configures the device to enable cloud web service interaction. The cloud web service interaction can correspond to a cloud storage or cloud storage account for a user. The device upon joining the system is granted with a unique device identifier (UUID) and a secret key. The unique device identifier and secret encryption key allow the device and the cloud to secure communications between them and helps achieving non-repudiation. As such, an authenticating agent authorises the device.

At block 106 the method comprises generating a ticket using the device unique identifier and user credentials. According to an example, a ticket is assembled by the device and comprises the device unique identifier issued previously by the cloud. The ticket may be assembled comprising one or more of the following: the ID of the authenticating agent (which authenticated the user within that device); any server, domain, or scope used to qualify the user; the user ID of the user which was authenticated, for example a qualified username or other unique ID.

At block 108 the method comprises signing the ticket with the encryption key. According to an example, the ticket may be signed or encrypted with keys derived from the secrets previously exchanged between the cloud and device. For example, both the device and the authorization system can participate on the same key domain so that the key derivation functions reach out to the same keys for the same key material attributes. As such, no two submissions of the ticket use the same key. Once created the ticket can be exchanged with the cloud to a cloud authorization endpoint.

At block 110 the method comprises sending the signed ticket to a cloud authorisation service.

At the cloud service, the signed ticket is validated at block 112 using the encryption key. According to an example, the cloud authorization can check whether this ticket is correctly signed and encrypted and is linked to a cloud account.

At block 114 the method comprises matching the ticket to the cloud storage account for the user via the user credentials. Upon finding a match, a user cloud session is created and an access token is issued and returned to the device to enable it to access private user assets such as storage.

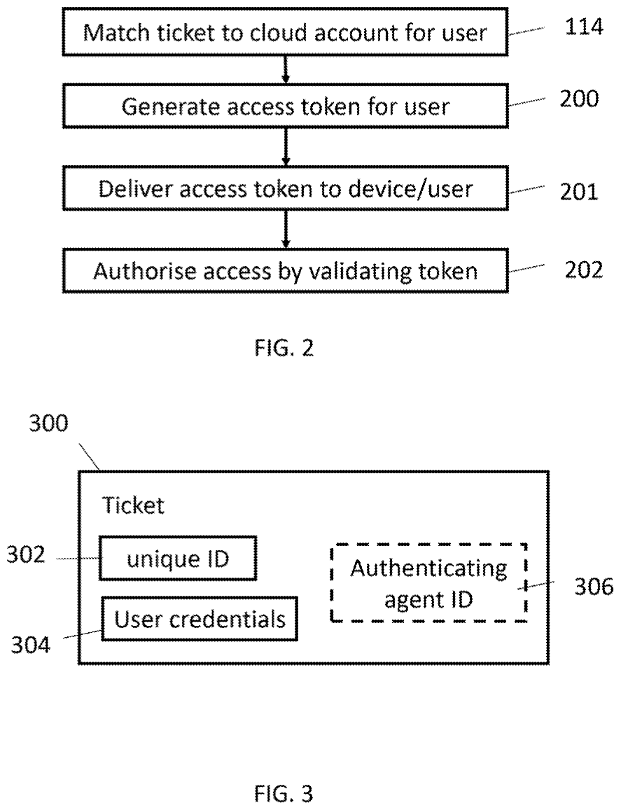

FIG. 2 shows an access token assigned to a user according to an example. An access token can be provided to the user for the purpose of linking the cloud storage account for the user to the authorised device. At block 200 an access token is generated for the user. For example, an access token can be created by the cloud service and delivered to the MFP device. The device can provide the access token to the user to access their cloud storage account to their authorised device (through the ticket). At block 201 the access token is delivered to the device and assigned to the user. According to an example, the device or MFP client can utilize the access token to access the cloud resources associated with that user's cloud account. For example, this may be to access linked storage such as OneDrive, GoogleDrive, Box, DropBox, and/or to access user preferences and settings such as frequent workflows or preferred language. At block 202 the access token is validated by the cloud services the device accesses on behalf of the authorised user.

FIG. 3 shows a ticket according to an example. The ticket 300 comprises the unique device identifier (UUID) 302 and user credentials 304. User credentials may include the user ID and any server, domain or scope used to qualify that user. This information is used to generate the ticket at the device. For example, the user credentials may be obtained via a user login, such as an RFID badge. According to an example, an authenticating agent identification 306 may be included in the generated ticket. The authenticating agent ID is an ID uniquely identifying the solution which performed the user authentication at the device as authorised by the device administrator. The encryption key used to sign the ticket may be provided by the cloud storage account.

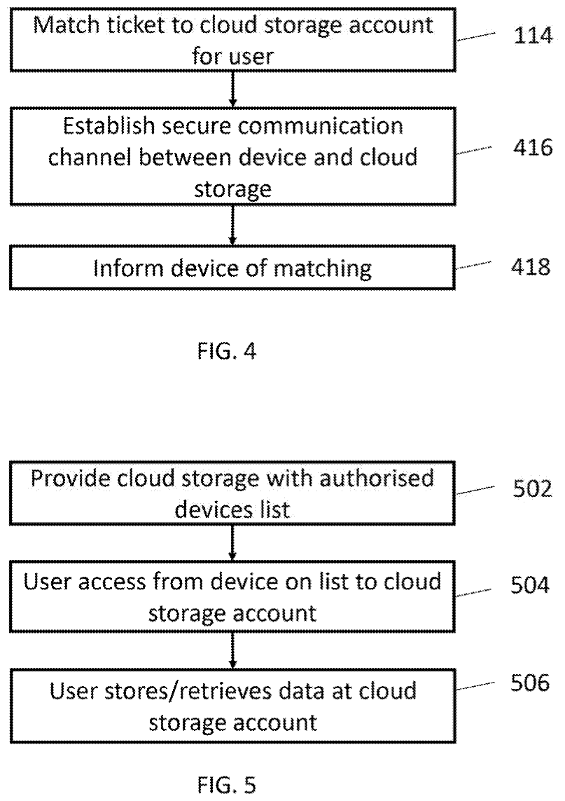

FIG. 4 shows a method for establishing a secure communication channel between a device and cloud storage according to an example. At block 114 the cloud service matches the ticket to a user storage account. According to an example, if the cloud storage finds that a ticket is not linked to a user account on the cloud storage, the cloud storage can inform the device. In this example, the cloud can present options for the user to grant permission for the account linkage (via one-time credential entry). According to an example, the cloud can present an option for the user to participate on the authorization service's flow that requests explicit grants or consent from the user. At block 416 a secure communication channel is established between the device and cloud storage. At block 418 the cloud storage informs the device of the matching.

FIG. 5 shows a method for the user to store and/or retrieve data at their cloud storage account according to an example. At block 502 the cloud storage is provided with a list of authorised devices. The list of authorised devices allows a user to access the cloud storage from a device within the group list. According to an example, the cloud authorization service can store a list of tenant MFP devices that are part of a group (e.g. within a given company). At block 504 the user can access their cloud storage account from any of those devices in the list. For example, once a linkage is created on a given device, a set of similarly managed and secured devices can be granted permission to link the same MFP and cloud accounts. This saves the user from having to perform the one-time linkage step at each MFP device. The cloud storage account for the user is accessible from any one of those authorised devices in the list without having to validate the signed ticket at that authorised device. According to an example, the cloud authorization service can also store whether a claim linkage has previously been declined by the user to allow the MFP client to avoid asking the user whether they would like to link their MFP account to their cloud account. As such, the user can access their cloud storage account at any one of those authorised devices without having to grant permission at each authorised device in the group.

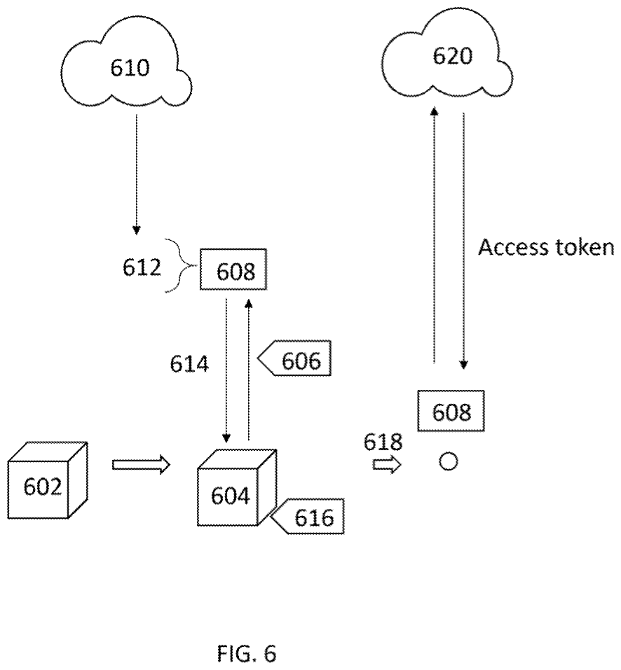

FIG. 6 shows use of an access token according to an example. A user 602 with an available access token may log in to an MFP device 604. For example, the user may log into the device from the control panel. After login, the printer can obtain an access token (and/or refresh token) from an authorization service, such as the cloud storage. This may be achieved using an authorization grant flow or a token exchange flow. The device may generate a ticket 606 using the access token. The ticket may be sent to a link app 608 associated with an enterprise or business cloud/intranet 610, or a third-party cloud 620, which stores the device client ID and secret key or authorization code. If the user is authorized to access the device and the cloud storage account, the authorization code 614 is returned to the device 604. An API may be offered for device solutions to request the data. Device solutions may keep or store the resulting access token. The device then uses the authorization code to encrypt or sign the ticket 616. The signed ticket is sent 618 from the device to the cloud storage 620, for example via the link app which connects the device to the cloud (user session context) for the user to access their cloud storage account.

The linking of the user to their cloud storage account from the authorized device may be achieved via a web flow, for example called on a browser. The local identity is configured to produce the same claims or tickets for a given user (i.e. stable ID's).

According to an example, when the user links the device to their cloud storage account, the secure communication channel may be time limited, for example valid for eight hours. If a user attempts to log into more than one authorized device, the secure communication channel optionally may not support multiple sessions.

According to an example of account linking, a user may log in on an MFP device using an existing local authorization domain (e.g. AD, Azure, LDAP) and then is offered to link that account to an existing or new user account, that will be used to fulfill personalization (and more) use cases. When logging in again on any other MFP device under the list of authorized devices (same local authorization system), the previously account linkage is discovered by the system and the user leverages this for automatic authorization at that device.

According to an example, the local user is able to either unlink a previously linked account, or determine not to link accounts, which may prevent the system to suggest linkage again.

According to an example, link apps may use a vault to store user credentials. For an installed link app on a device, the link app can leverage the user identity that is logged in the device, so the link apps do not request users to log in again on behalf of the app to use, for example, personalization services. This procedure allows a link app to obtain an authorized asset that the app can use against services (such as the vault), under the app's scoping and identity (i.e. the app's client ID). The procedure may be secure such that link apps do not have access to the original authorization asset present on the device.

According to an example, a reverse direction of linkage may be offered as an option, allowing users who log in to their cloud account (e.g. via mobile phone confirmation, gesture, swipe) to be authorized locally by an embedded authentication agent as a device user. The device can be linked to the cloud authentication directly as the installed authenticating agent, logging into the cloud directly, with restrictions on the domain or authentication provider which is acceptable as an MFP authenticating provider.

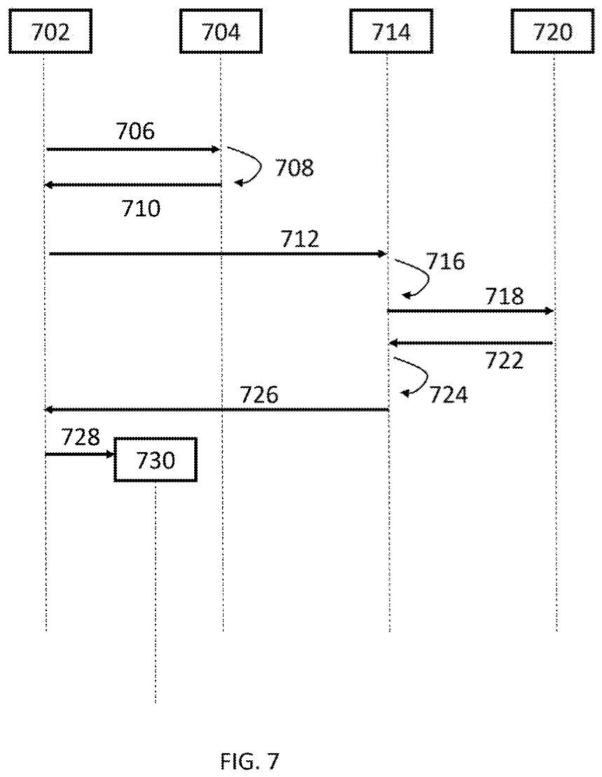

FIG. 7 shows authentication between a device and a cloud storage account for a user according to an example. A link app 702 has the device ID and secret key. The link app is in communication with the device or device firmware 704. The device may already have an access token that identifies a user, which may have been obtained directly or from a session exchange. For example, the device can access an OTP or service key. An internal API of the link app 702 calls or requests 706 an authorisation code from the device. The device then generates 708 a ticket embedding the original access token that identifies the current user that is logged into the device. The ticket is encrypted with an OTP which acts as the authorisation code. The signed or encrypted ticket is returned 710 to the link app. The link app 702 then exchanges 712 the token which is authorised with the app ID and secret key to a cloud storage 714. The cloud storage validates 716 the app credentials by determining the authorities based on the corresponding API product metadata. The cloud storage 714 fetches the OTPs 718 for the previously known service ID and indicated cloud ID 720. The OTP is used to decrypt and validate the ticket 722. The embedded access token is retrieved and validated which may include fetching keys. The access token is used to match the ticket to the user's storage account. A new or updated access token may then be generated 724 and signed, where the new access token is specific to the user account and the link app client ID. The new access token can then be returned 726 to the link app 702. The link app, now having the access token under the app's domain is able to call 728 a vault 730 to help achieving app isolation. The user may then access their cloud storage account and store/retrieve data at the cloud storage.

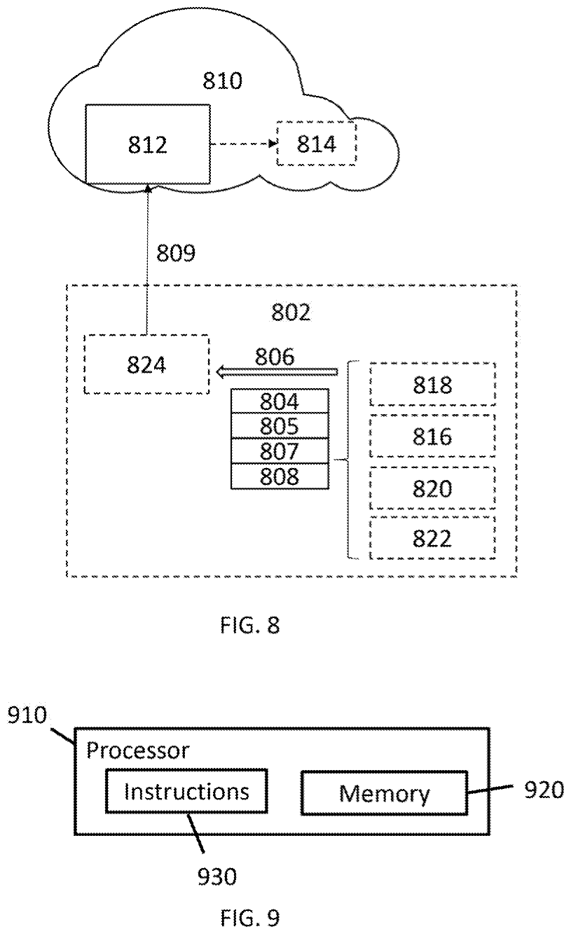

FIG. 8 shows a system for providing authentication between a device and a cloud storage account for a user according to an example. The system comprises a multi-function device 802 having a unique identifier 804 and an encryption key. The device is configured to authorise credentials for a user. For example, access control may be enforced at the device to support user authentication by providing the user with an access token. The device is connectable to a network. An administrator can pre-configure or authorise one or more devices to connect to the cloud storage. The, or each, device is assigned a unique identifier (UUID) and secret key. This enables a secure communication channel between the, or each, device and the cloud storage. The device is configured to generate a ticket 806 using the device unique identifier and user credentials. The ticket may be generated using an authenticating agent ID 805, username of logged in user 807, or a server ID 808. The device is configured to sign the ticket with the encryption key. The device is configured to send 809 the signed ticket to a cloud storage 810. The cloud storage is configured to validate 812 the signed ticket using the encryption key. The cloud storage then matches the ticket to the cloud storage account for the user via the user credentials. Where a list of authorised devices 814 is provided to the cloud storage, the matching of the ticket may comprise accessing the list of authorised devices. This securely links the embedded MFP device or printer authentication to the users cloud storage account. The cloud storage or cloud services provide authentication and authorisation for the user to store/retrieve their personal data from their cloud account.

According to an example, the administrator of the device can set the authentication method, e.g. built-in authentication agent such as LDAP 816, Windows 818, or an installed solution such as Safecom, HP Access Control. The user can access or log into the device using an RFID badge 820, for example, or an authorised third party may securely access the device 822. According to an example, a private user session may be enabled via a link app 824.

The method and system disclosed provide a secure and convenient linking of a user's cloud storage account to the MFP device that the user is logged into. It provides the end user with ease of use since the user may sign in once with support for link app isolation. This has the advantage of securely allowing the user to log-in once at the device for combined access to the device and their cloud account. This removes a secondary login that the user would otherwise perform to access third party services, since instead the user can be logged into their cloud account securely and automatically. The login is secure in that the authorized device(s) are able to automatically bridge from MFP device login to cloud login. As such, there is provided a method and system for authentication of an MFP device and a cloud authorization domain, without a user re-authenticating or re-entering secondary credentials. The user is provided with secure access to their personal assets, configuration and experience without multiple credential entry. This allows bridging between local and cloud authorization domains whilst keeping the user's account secure from unauthorized access from malicious attack (hackers).

Examples in the present disclosure can be provided as methods, systems or machine-readable instructions, such as any combination of software, hardware, firmware or the like. Such machine-readable instructions may be included on a computer readable storage medium (including but not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. In some examples, some blocks of the flow diagrams may not be necessary and/or additional blocks may be added. It shall be understood that each flow and/or block in the flow charts and/or block diagrams, as well as combinations of the flows and/or diagrams in the flow charts and/or block diagrams can be realized by machine readable instructions.

The machine-readable instructions may, for example, be executed by a general-purpose computer, a special purpose computer, an embedded processor or processors of other programmable data processing devices to realize the functions described in the description and diagrams. In particular, a processor or processing apparatus may execute the machine-readable instructions. Thus, modules of apparatus may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate set etc. The methods and modules may all be performed by a single processor or divided amongst several processors.

Such machine-readable instructions may also be stored in a computer readable storage that can guide the computer or other programmable data processing devices to operate in a specific mode.

For example, the instructions may be provided on a non-transitory computer readable storage medium encoded with instructions, executable by a processor.

FIG. 9 shows an example of a processor 910 associated with a memory 920. The memory 920 comprises computer readable instructions 930 which are executable by the processor 910. The instructions 930 comprise:

at the device,
Instructions to authorise credentials for the user;
Instructions to authorise the device by providing a unique identifier and an encryption key;
Instructions to generate a ticket using the device unique identifier and user credentials;
Instructions to sign the ticket with the encryption key;
Instructions to send the signed ticket to a cloud storage;
at the cloud storage,
Instructions to validate the signed ticket using the encryption key; and
Instructions to match the ticket to the cloud storage account for the user via the user credentials.

Such machine-readable instructions may also be loaded onto a computer or other programmable data processing devices, so that the computer or other programmable data processing devices perform a series of operations to produce computer-implemented processing, thus the instructions executed on the computer or other programmable devices provide an operation for realizing functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. In particular, a feature or block from one example may be combined with or substituted by a feature/block of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method for providing authentication between a device and a cloud storage account for a user, comprising:
at the device,
authorising credentials for the user;
authorising the device by providing a unique identifier and an encryption key;
generating a ticket using the device unique identifier and user credentials;
signing the ticket with the encryption key;
sending the signed ticket to a cloud authorisation service;
at the cloud authorisation service,
validating the signed ticket using the encryption key; and
matching the ticket to the cloud storage account for the user via the user credentials.

2. A method according to claim 1, further comprising assigning an access token to the device after validating and matching.

3. A method according to claim 2, wherein the device assigns the access token to the user.

4. A method according to claim 2, further comprising providing the access token to link the cloud storage account for the user to the authorised device.

5. A method according to claim 1, wherein an authenticating agent authorises the device.

6. A method according to claim 3, wherein the ticket is generated using an identification for the authenticating agent.

7. A method according to claim 1, further comprising establishing a secure communication channel between the device and the cloud storage account for the user.

8. A method according to claim 1, further comprising at the cloud storage informing the device of the matching.

9. A method according to claim 1, further comprising providing the cloud storage with a list of authorised devices.

10. A method according to claim 9, wherein the cloud storage account for the user is accessed at any one of those authorised devices in the list.

11. A method according to claim 1, wherein the user stores or retrieves data at the cloud storage account.

12. A system for providing authentication between a device and a cloud storage account for a user, comprising:
a multi-function device having a unique identifier and an encryption key, the device configured to authorise credentials for the user, generate a ticket using the device unique identifier and user credentials, sign the ticket with the encryption key, and send the signed ticket to a cloud authorisation service; and
a cloud authorisation service configured to validate the signed ticket using the encryption key and match the ticket to the cloud storage account for the user via the user credentials.

13. A system according to claim 12, wherein the cloud storage comprises a list of authorised devices.

14. A system according to claim 12, wherein the cloud authorisation service is configured to create and deliver an access token to the device.

15. A non-transitory machine-readable storage medium encoded with instructions executable by a processor for providing authentication between a device and a cloud storage account for a user, the machine-readable storage medium comprising instructions to:
authorise credentials for the user;
authorise the device by providing a unique identifier and an encryption key;
generate a ticket using the device unique identifier and user credentials;
sign the ticket with the encryption key;
send the signed ticket to a cloud authorisation service;
validate the signed ticket using the encryption key;
match the ticket to the cloud storage account for the user via the user credentials; and
send an access token to the device upon successful ticket validation and matching.
